(19) United States
(12) Patent Application Publication
(10) Pub. No.: US 2005/0071362 A1
(43) Pub. Date: Mar. 31, 2005

(54) Enterprises taxonomy formation method and system for an intellectual capital management system

(76) Inventors: Brent Dalmas Nelson, Plano, TX (US); Gregory Dale McGee, Rockwall, TX (US)

Correspondence Address: FORTKORT GRETHER + KELTON LLP, 8911 N. CAPITAL OF TEXAS HWY., SUITE 3200, AUSTIN, TX, 78759, US

(21) Appl. No.: 10/675,075

(22) Filed: Sep. 30, 2003

(51) Int. Cl. G06F 7/00

(52) U.S. Cl. 707/102

(57) ABSTRACT

A method and system for constituting an integrated enterprise taxonomy(222) for an intellectual capital management system serving a plurality of local enterprise communities(80) and include the steps of and instructions for extracting a plurality of local taxonomies from the plurality of local enterprise communities(224, 240). The invention correlates from each of the plurality of local taxonomies a set of topics(164) and a set of associations(168) for generating a correlated topics and associations set(160) relating to each of the plurality of local taxonomies(224, 240). The system and method further derive a plurality of synonym links(262, 264, and 266) for linking synonyms within the correlated topics and associations set(260). The invention integrates the plurality of synonym links and the correlated topics and associations set into an integrated enterprise taxonomy(222). Then, the method and system export the integrated enterprise taxonomy into the intellectual capital management system.

### TECHNICAL FIELD OF INVENTION

The invention, in general, relates to an enterprise taxonomy formation method and system for an intellectual capital management system and, more particularly, to a method and system for constituting an integrated enterprise taxonomy for an intellectual capital management system serving a plurality of local enterprise communities.

### BACKGROUND OF THE INVENTION

Computer software systems effectively model many types of physical and organizational systems. One type of modeling system may be an object-oriented modeling system. An object-oriented modeling system establishes a computer-based environment replicating an actual environment or interactive system or set of systems. Object-oriented modeling systems constitute objects, relationships, and models, which are sets of object types and relationship types, etc., and are implemented in a mark-up language such as XML. One such object-oriented modeling environment is known as a metamodeling environment, which is used to create the object types, relationship types, etc. to be used in building models.

A metamodeling environment enables building models of business processes, such as an enterprise for which an enterprise architecture model may be developed. The metamodel addresses the need to understand increasingly complex enterprises, enabling decision makers and those carrying out the everyday work of sharing and implementing a common understanding, which may be represented as a visual model. The metamodeling model forms the basis for making informed decisions, since it becomes possible to reveal the complex interplay within the enterprise model.

An enterprise architecture model enables the illustration and depiction of enterprises and their ongoing processes, customers and suppliers. A metamodeling environment for an enterprise provides an illustrative domain for depicting how processes and relationships within an enterprise interact with one another rise. A desired metamodeling system does not restrict the user to a particular methodology for modeling, but provides templates for the modeling of different domains. The metamodel also permits the author to provide data and instructions directly into the model or import data from other applications, as well as to analyze models and access data outside of the model.

In the field of enterprise architecture, the strengths of a metamodeling system clearly appear. In order to optimize the use of information technology by complex, global organizations, enterprise architects use such a tool to not only represent complexity, but also to analyze such complexity. This allows them to produce intelligible output to many different user groups quickly and completely.

In the field of intellectual capital management, a wide variety of work may arise in which a vast array of technologies, products, services, methodologies, and designs may arise for customers in all industries. One intellectual capital management objective involves enabling employees to leverage work they have already completed. In general, this leveraging may be accomplished using various documents which record the logic and thought processes used in solving similar types of problems. Such documents may be classified according to their contents, as they are found and used by other knowledge workers.

An intellectual capital management system may operate within an enterprise architecture modeling system to support different local communities in their knowledge management needs. Such a system would interface the different vocabularies or taxonomies for the various local communities with which it may interface. Because there may be many different communities, a different taxonomy may associate with or support each community. At the same time, an enterprise taxonomy can connect together these different community taxonomies.

To achieve this and similar ends, a needs exists for a taxonomy management tool for addressing differing requirements from different taxonomies. The need for such a knowledge engine includes the need for providing a taxonomy for organizing different types of knowledge. Such a taxonomy would provide a way to classify intellectual capital to logically and retrievably organize these assets. In a knowledge-sharing environment, therefore, a need exists for a method of classifying an organization's intellectual capital or knowledge. A need also exists for a structure permitting the formation of a taxonomy for labeling and identifying the intellectual capital.

A need exists for a system facilitating the extraction of information from documents and information sets relating to a particular community or sub-community. Furthermore, enterprise model developers need a method and system addressing the problem of different communities having different vocabularies. One particularly challenging aspect of this phenomenon relates to the phenomenon of identical objects or names having differing meanings across various communities. For example, one community may identify those companies or individuals for whom they provide products or services as “customers.” Whereas others may refer to the same companies or individuals as their “clients.” For a software company, this distinction although slight, may be particularly challenging because the word “client” also relates to particular pieces of software and hardware in a “client-server” computer system environment, or to the “client-server system architecture.”

Intellectual capital management systems and methods also require a method and system for addressing the different types of abbreviations or acronyms existing between different communities, wherein a same or similar acronym or abbreviation may have significantly different meanings across communities. Still further, those focusing on intellectual capital management need a method and system addressing the problem of many different words in any community relating to the same particular item or circumstance. For example, in a community or community segment, where there may be hundreds of particular terms relating to the work of a community or community segment. Accordingly, the management and tracking of these particular terms can be a daunting task.

### SUMMARY OF THE INVENTION

The present invention provides an enterprise taxonomy formation method and system for an intellectual capital management system which substantially eliminates or reduces the disadvantages and problems associated with prior methods and systems for forming taxonomies applicable to enterprise architecture modeling, intellectual capital management system modeling and related processes.

According to one aspect of the present invention, there is provided a method and system for constituting an integrated enterprise taxonomy for an intellectual capital management system serving a plurality of local enterprise communities and which includes the steps of and instructions for extracting a plurality of local taxonomies from the plurality of local enterprise communities. The invention correlates from each of the plurality of local taxonomies a set of topics and a set of associations for generating a correlated topics and associations set. The correlated topics and associations set relates to each of the plurality of local taxonomies. The system and method further derive a plurality of synonym links for linking synonyms within the correlated topics and associations set. The invention integrates the plurality of synonym links and the correlated topics and associations set into an integrated enterprise taxonomy. Then, the method and system export the integrated enterprise taxonomy into the intellectual capital management system.

A technical advantage of the present invention includes an enterprise taxonomy for classifying structures useful in organizing and labeling entities and relationships in a model. In the discipline of knowledge management, and specifically intellectual capital management the present invention provides a classification scheme for organizing documents about technology, markets, methodologies, etc.

Another technical advantage of the present invention includes providing a community-oriented approach for a particular taxonomy set. At the same time, the present invention provides an enterprise approach allowing an integrated view of the taxonomies across the different communities and community segments.

One aspect of the present invention includes providing an enterprise taxonomy in a community-by-community approach. For example, a community may be defined as a group of individuals who work for some common benefit or some common endeavor of a similar type, such as, for example, a sales force within an enterprise. All members of the sales force may do a similar type of work, e.g., selling the goods and services for a particular company. There may also be different types of models applicable to these different communities, as well as different segmentations within a given community.

A technical advantage of the present invention includes the ability to receive preexisting models applicable to a community or a community segment and incorporating the particular taxonomy into a uniform taxonomy structure. This contrasts to known approaches of creating a wholly new enterprise taxonomy, which may not be useful for one or more communities within the enterprise. The present invention provides the ability to extract a taxonomy from a preexisting model to create a taxonomy for use in a knowledge management system. Such a taxonomy will be useful for creating a way of reviewing and cataloguing a particular community or community segment's documents and information. As a result of the present invention the taxonomy management system puts to use the taxonomy of a particular community or community segment.

A particular advantage of the present invention includes using the Metis© modeling tool to facilitate enterprise taxonomy formation and navigation. For the present invention, the Metis© software environment provides a semantic network style of enterprise taxonomy. Although the Metis© modeling tool is not used as the tool by which the user accesses the community or community segment specific taxonomy; the present invention exports the taxonomy from Metis© in a tab delimited format. Such a set of information would be transported into a knowledge management system for use by a particular community or community segment. The present invention makes use of a single tool, such as the Metis© software program for the purpose of implementing many different types of taxonomies applicable to different communities and community segments. In such an environment, the local communities may use a separate software tool or system differing from the Metis© system.

The present invention further provides the advantage of structuring the enterprise taxonomy as a tree structure. This provides the ability to view the taxonomies as hierarchically linked nodes within the tree structure. Accordingly, this structure facilitates the migration from highly general classifications to more specific or narrowly defined classifications within a given taxonomy.

Other technical advantages are readily apparent to one skilled in the art from the following FIGUREs, description, and claims.

### BRIEF DESCRIPTION OF THE DRAWINGS

For a more complete understanding of the present invention and advantages thereof, reference is now made to the following description which is to be taken in conjunction with the accompanying drawings and in which like reference numbers indicate like features and further wherein:

FIG. 1 illustrates a computing system employing the teachings of the present invention;

FIGS. 2a and 2b show a graphical user interface for an enterprise metamodel system which may employ the teachings of the present invention;

FIG. 3 presents one example of a consistent taxonomy for employing within the method and system of the present invention;

FIG. 4 depicts the Zachman Framework, an exemplary process for constituting an enterprise taxonomy according to the teachings of the present invention;

FIG. 5 shows an exemplary integrated enterprise taxonomy formed according to the teachings of the present invention;

FIG. 6 illustrates the use of synonymy links according to the teachings of the present invention;

FIG. 7 provides an overall view of a taxonomy model according to the teachings of the present invention; and

FIG. 8 is an example of a consistent section of an enterprise taxonomy employing the concepts of the present invention.

### DETAILED DESCRIPTION OF PREFERRED EMBODIMENT

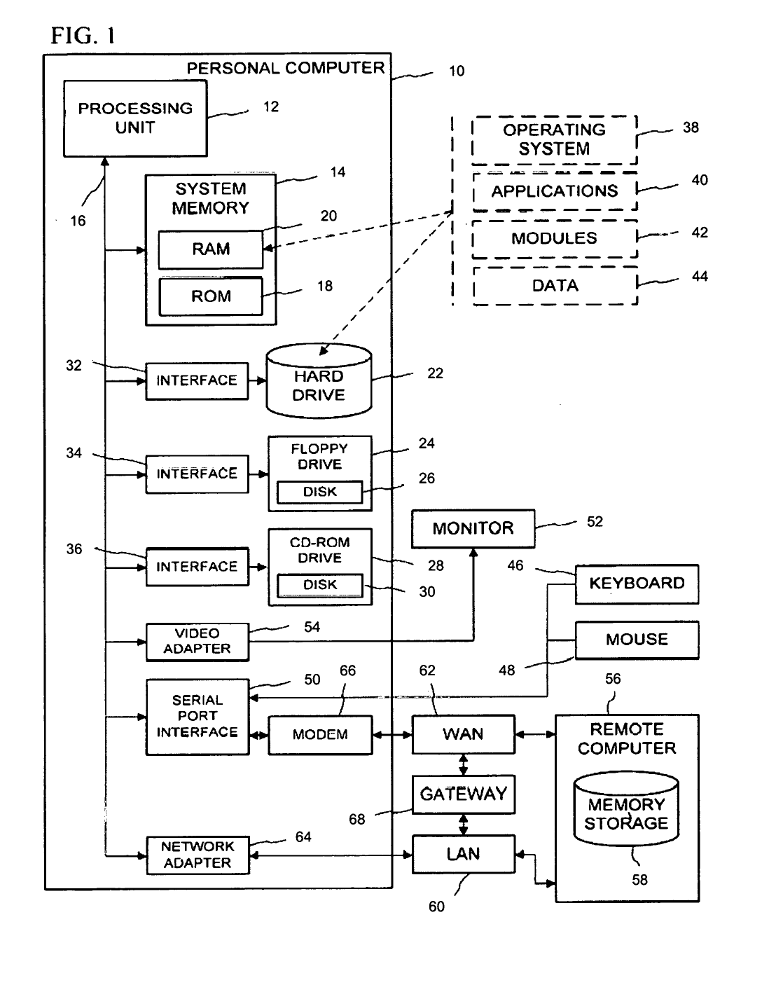

The preferred embodiment of the present invention and its advantages are best understood by referring to FIGS. 1 through 6 of the drawings, like numerals being used for like and corresponding parts of the various drawings.

FIG. 1 illustrates a general-purpose computer 10 for using the present invention's method and system for constituting an integrated enterprise taxonomy. By associating a network of general-purpose computers 10, the present invention is useable in an intellectual capital management system serving a plurality of local enterprise communities. General-purpose computer 10 may be used as a stand-alone computer or as part of a larger, networked system of personal computers such as in an enterprise. Using at least two such computers, for example, the present invention makes possible metamodel system files at different locations within a given enterprise. Here, FIG. 1 provides an understanding of how one might use the system of the present invention. General-purpose computer 10 may be used to execute distributed applications and/or distributed and individually operating system services through an operating system.

With reference to FIG. 1, an exemplary system for implementing the invention includes a conventional computer 10 (such as personal computers, laptops, palmtops, set tops, servers, mainframes, and other variety computers), including a processing unit 12, system memory 14, and system bus 16 coupling various system components including system memory 14 to the processing unit 12. Processing unit 12 may be any of various commercially available processors, including Intel x86, Pentium® and compatible microprocessors from Intel® and others, including Cyrix®, AMD® and Nexgen®; MIPS® from MIPS Technology®, NEC®, Siemens®, and others; and the PowerPC® from IBM and Motorola. Dual microprocessors and other multi-processor architectures also can be used as the processing unit 12.

System bus 16 may be any of several types of bus structures including a memory bus or memory controller, a peripheral bus, and a local bus using any of a variety of conventional bus architectures such as PCI, VESA, AGP, Microchannel, ISA and EISA, to name a few. System memory 14 includes read only memory (ROM) 18 and random access memory (RAM) 20. A basic input/output system (BIOS), containing the basic routines helping to transfer information between elements within the computer 10, such as during start-up, is stored in ROM 18.

Computer 10 further includes a hard disk drive 22, a floppy drive 24, e.g., to read from or write to a removable disk 26, and CD-ROM drive 28, e.g., for reading a CD-ROM disk 30 or to read from or write to other optical media. The hard disk drive 22, floppy drive 24, and CD-ROM drive 28 are connected to the system bus 16 by a hard disk drive interface 32, a floppy drive interface 34, and an optical drive interface 36, respectively. The drives and their associated computer-readable media provide nonvolatile storage of data, data structures, computer-executable instructions, etc. for computer 10. Although the description of computer-readable media provided above refers to a hard disk, a removable floppy and a CD, those skilled in the are may appreciate other types of media which are readable by a computer, such as magnetic cassettes, flash memory cards, digital video disks, Bernoulli cartridges, and the like, being used in the exemplary operating environment.

A number of program modules may be stored in the drives and RAM 20, including an operating system 38, one or more application programs 40, other program modules 42, and program data 44. A user may enter commands and information into the computer 10 through a keyboard 46 and pointing device, such as mouse 48. Other input devices (not shown) may include a microphone, joystick, game pad, satellite dish, scanner, or the like. These and other input devices are often connected to the processing unit 12 through a serial port interface 50 coupling to the system bus, but possibly connecting by other interfaces, such as a parallel port, game port or a universal serial bus (USB). A monitor 52 or other type of display device is also connected to the system bus 16 via an interface, such as a video adapter 54. In addition to the monitor, computers typically include other peripheral output devices (not shown), such as speakers and printers.

Computer 10 may operate in a networked environment using logical connections to one or more remote computers, such as a remote computer 56. Remote computer 56 may be a server, a router, a peer device or other common network node, and typically includes many or all of the elements described relative to the computer 10, although only a memory storage device 58 has been illustrated in FIG. 1. The logical connections depicted in FIG. 1 include a local area network (LAN) 60 and a wide area network (WAN) 62. Such networking environments are commonplace in offices, enterprise-wide computer networks, intranets and the Internet.

When used in a LAN networking environment, the computer 10 is connected to the LAN 60 through a network interface or adapter 64. When used in a WAN networking environment, computer 10 typically includes a modem 66 or other means for establishing communications (e.g., via the LAN 60 and a gateway or proxy server) over the wide area network 62, such as the Internet. Modem 66, which may be internal or external, is connected to the system bus 16 via the serial port interface 50. In a networked environment, program modules depicted relative to the computer 10, or portions thereof, may be stored in the remote memory storage device 58.

Those skilled in the art may appreciate the network connections shown as exemplary, wherein other means of establishing a communications link between the computers may be used. FIG. 1 only provides one example of a computer useful for employing the teachings of the present invention. The invention may be used in computers other than general-purpose computers, as well as on general-purpose computers without conventional operating systems.

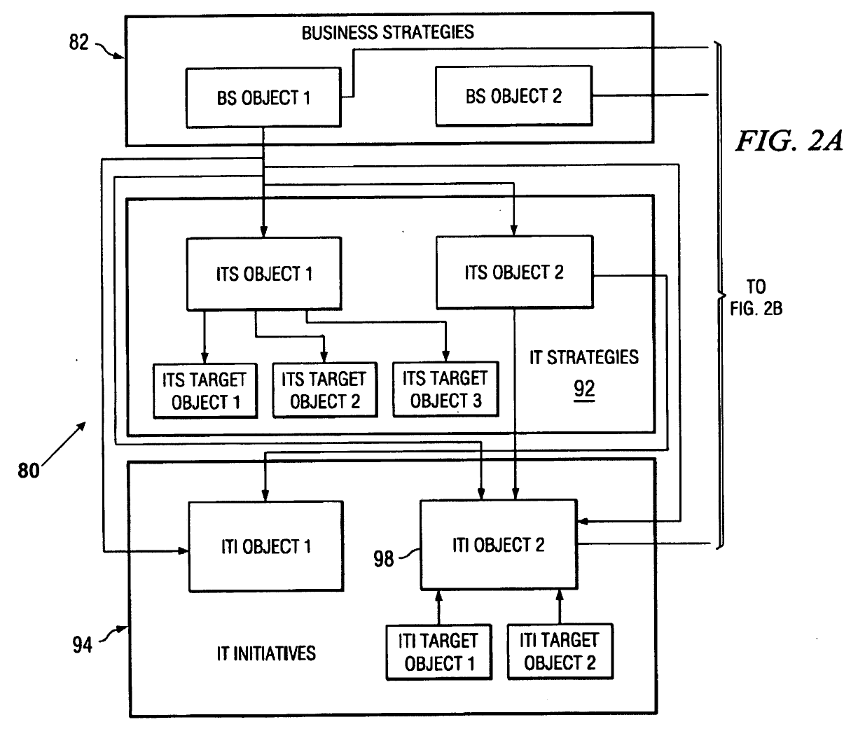

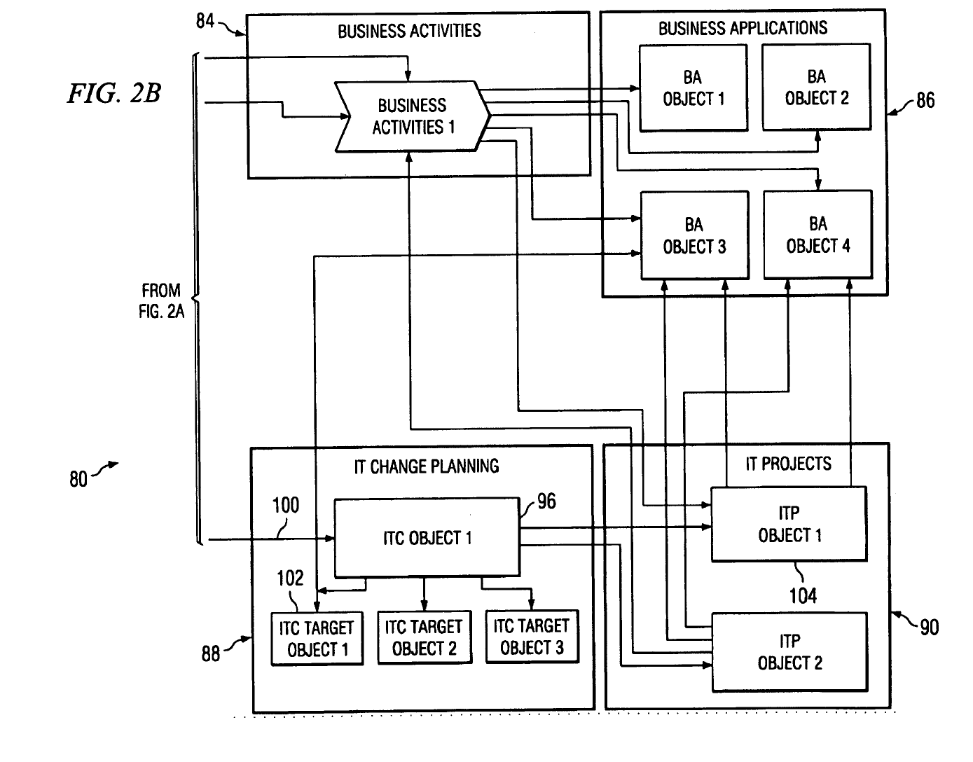

FIGS. 2a and 2b show a graphical user interface for an enterprise metamodel system which may employ the teachings of the present invention. FIGS. 2a and 2b also usefully depict general relationships and objects appearing in the various components of an enterprise metamodel. These, for instance, may include business strategies component 82, business activities component 84, business applications component 86, IT change planning component 88, IT projects component 90, IT strategies component 92, and IT initiatives component 94.

Within each component, such as IT change planning component 88, appear visualizations of objects, such as change plan object 96. Change plan object 96 associates with IT initiatives object 98, as relationship object or connector 100 depicts. Change plan object 96 may also associate with certain IT change planning sub-objects 102 for different functions, such as in this instance, IT change planning. Outputs from change plan object 96 may further pass to IT projects object 104 within IT projects component 92. Thus, with metamodel graphical user interface 80, the user may create a visualization of a functional metamodel of an enterprise.

The following discussion describes in a little further detail some concepts relating to enterprise model development and its relation to implementing an enterprise taxonomy development. A model is a useful representation of some subject which provides an abstraction of reality expressed in terms of some computer system and related language. Models can provide consistent and inherently understood semantic interpretations of systems, such as, in this instance, an enterprise taxonomy.

A metamodel is a definition or collection of definitions for using objects and relationships in a model. Specifically, a metamodel defines object types, relationship types, symbols, and methods, as well as criteria useful for searching a model. Metamodel information related to a particular area of knowledge is grouped into domains. The templates and model include references to specific domains to designate which object types, relationship types, methods, and search criteria can be used in a model.

An enterprise model provides a structure and repeatable processes for obtaining facts and data for an organization's leadership, helping organization members to make informed decisions supporting the enterprise's particular vision. The enterprise model may include of components such as enterprise operations framework; an investment strategy; an integration roadmap and governance. The enterprise model models an enterprise system, which is any integrated solution for linking business processes, data and applications across functions, geographies and business units within an enterprise. The enterprise operations framework provides a complete systems view of how an organization operates today and in the future to achieve its vision of becoming the global leader in the digital economy. It is the foundation for the overall systems design and operation, and represents how an organization will operate, verifies the system's current operational state, and indicates where and how current initiatives are changing the systems base. The enterprise operation framework provides the structure and repeatable methods to employ other components of the enterprise model, such as the investment strategy, the integration roadmap or the governance.

A metamodel system is designed to accommodate diverse needs in large corporations. The structure of the metamodel system includes a system editor module, which allows the user to build and maintain models. The system designer module includes additional features for setting up and defining model structures. It also comes with a symbol editor, allowing changes in the visual appearance of model elements. The metamodel developer makes possible customizing metamodels, and developing support for new standards and frameworks. When publishing models on an Intranet (or on the Internet), a metamodel browser may give the user the full visual power of a metamodel in read-only mode. The metamodel may also include a system annotator which can be regarded as a browser with the added capability of creating annotations or comments on objects in existing models. These annotations become visible to the owner of the model, who may then review them. Common features for the different system modules include the properties of them all being stored as XML-files with designer/editor functions scriptable over COM-interface. Graphics for such a model are SVG (Scalable Vector Graphics) and the module designer may include a built-in editor and import function. Custom queries in such a system may be easily pre-defined and run from action-buttons.

A metamodel system may form from a collection of object types, relationship types, methods, and search criteria related to a particular area of knowledge. For example, a metamodel may include templates for an organization and its resources as they may be used in the operation of an enterprise. Whereas, a model includes groups of related objects and relationships for representing information about an enterprise. Models permit analyzing complex systems, to help answer business questions, and to solve business problems. Attractive modeling system provide graphical interfaces including one or more model views helping to organize and display modeled information in a meaningful way.

A useful metamodel system provides a visual modeling tool allowing a user to understand increasingly complex enterprises. This enables decision makers and those who carry out the work of an enterprise to share a common understanding, all represented as a visual model. The model forms the basis for making informed decisions, since it becomes possible to reveal the complex interplay within the enterprise.

A model data file contains model data in the form of objects and relationships. A metamodeling system may receive new files and relocate objects between model data files. In a metamodel system, a type label includes the name of the object or relationship type the metamodel displays for the user. A component of a model is an object, which represents a specific piece of information about an enterprise (for example, a process, sub-process, process input, process output, or document). An object is created from an object type and values are set for the properties defined in the object type. An object is referenced through its Uniform Resource Identifier (URI). Objects are graphically represented on the screen through object views.

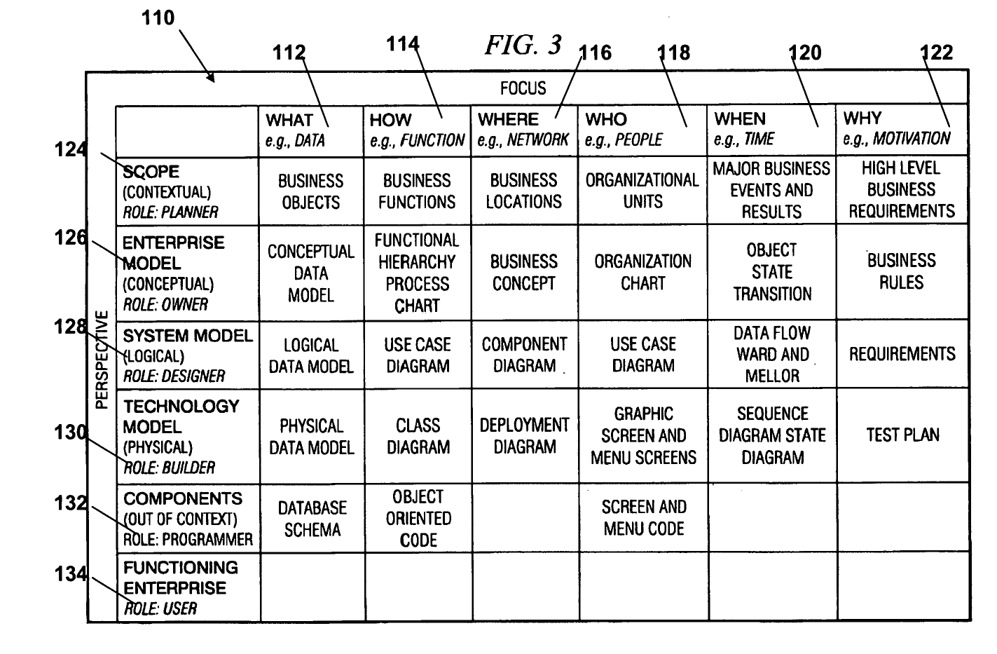

FIG. 3 presents one example of a consistent taxonomy for employing the teachings of the present invention, which is known as the Zachman Framework for Enterprise Architecture, appearing as framework matrix 110. Such a framework may aid in establishing an enterprise architecture structure and function for a metamodel system. In framework matrix 110, columns relate to functions, while rows relate to the different structural roles potentially existing in a particular enterprise. Thus, What column 112 relates to data, How column 114 relates to functions within the enterprise, Where column 116 relates to network locations, Who column 118 relates to people within the enterprise, When column 120 relates to time for different functions, and Why column 122 relates to motivation within the enterprise.

At the various enterprise levels, Scope row 124 relates to the planner role, Enterprise Model row 126 relates to the owner role, System Model row 128 relates to the designer role, Technology Model row 130 relates to the builder role, Components row 132 relates to the programmer role, and Functioning Enterprise row 134 relates to the enterprise architecture model user. Within the cells at the intersection of functions columns 112 through 122 with enterprise role rows 124 to 134 are potential standards-compliant entity names. Thus, using a standard format and the standard terminology of framework matrix 110, the ability to form a standards-compliant enterprise architecture standardized entity names results. In a standards-compliant metamodel, moreover, each entity may be in separate files which are strictly organized according to entity type.

Framework matrix 110 provides an example of a tool for integrating different taxonomies associated with different communities or community segments. For example, the community taxonomies may be considered as logical trees interconnecting with different roots into the enterprise. Such roots may interconnect at the enterprise level, but would emerge from the enterprise into their various taxonomical branches according to the community or community segment. By virtue of linking the different taxonomies at the enterprise level, the present invention makes it possible to navigate from one taxonomy to another as a user or other system seeks a particular phrase or word.

The present embodiment of the invention uses the Metis® modeling tool. The present invention makes it possible to review the components within each cell for the purpose of determining whether there are synonyms across industries or communities or community segments. In particular, the present invention may provide this segregation of elements within a particular cell of the Zachman framework. The Metis® tool, which stores metamodels and models as XML files, facilitates navigating throughout the metamodel system, and, as such, permits semantic network navigation within a taxonomy management system. For the present invention, the Metis© software environment provides a semantic network taxonomy making use of a semantic network programming tool. The present embodiment exports the taxonomy from Metis© in a tab delimited format. Such a set of information may be used by an associated intellectual capital management system for use by a particular community or community segment. The preferred embodiment uses the Metis© tool to implement different taxonomies and, thereby, apply the different taxonomies and the resulting enterprise taxonomy to different communities and community segments.

The present invention extracts from the local model a local taxonomy, where by the word “local” is meant a single community. For example, the transportation industry community may use a model and extract from the model a set of terms. Such a community may be within a particular industry such as the transportation industry, or within particular segments of an industry such as the aviation transportation industry, or across different communities of interest such as the physical security community. Thus, communities may be established according to many different focuses, such as a technical focus or a particular business segment focus or other type of gatherings or groupings of interest.

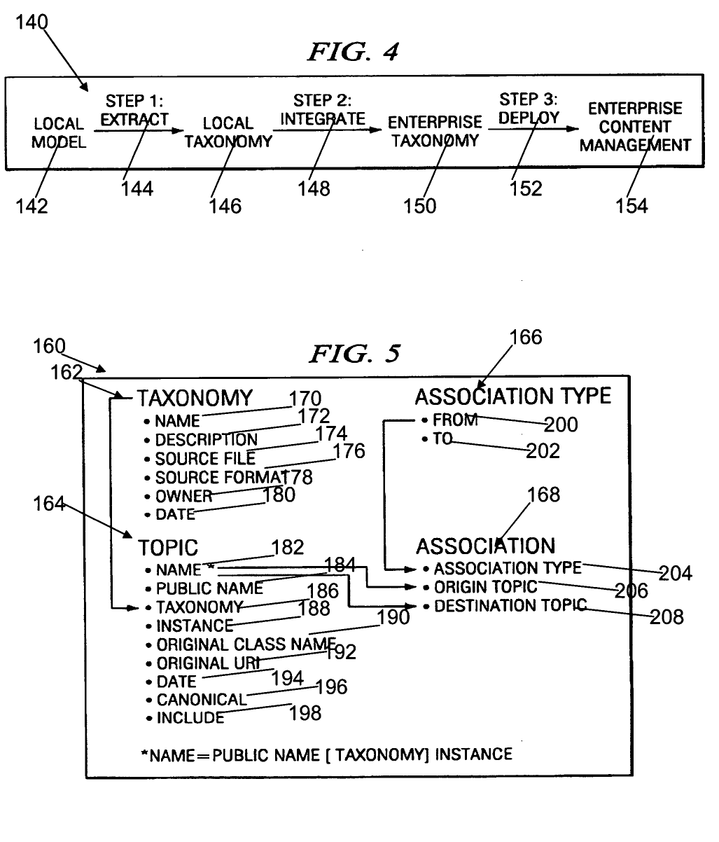

FIG. 4 depicts exemplary enterprise taxonomy process 140 for constituting an enterprise taxonomy according to the teachings of the present invention. From a local model or community 142, process 140 extracts at step 142 a local taxonomy 144. The local taxonomy is integrated at step 146 into enterprise taxonomy 148. Step 150 represents deployment of enterprise taxonomy 148 in the enterprise content management 152.

Thus, where a local community has a local model 142 which includes a local taxonomy 146, step 144 involves determining the quality and completeness of local model 142 and local taxonomy 146. Once the content of a local taxonomy 146 is identified, enterprise taxonomy process 140 further includes the step of analyzing and modifying local taxonomy 146 to increase its internal consistency. With a set of highly heterogeneous models, this can require a measure of attention. This step involves addressing the varying levels of sophistication arising in the different models relating to different types of communities or community segments. For example, some models within some communities may be highly technically robust and have complete referential integrity. On the other hand, some other communities or community segments may not have the same level of robust referential integrity. However, for most local models 142, extraction step 144 can be accomplished.

The present invention also addresses the problem of different communities having different vocabularies. One particularly challenging aspect of this phenomenon occurs when, across communities, an identical object or an identical item may have different words relating to it. This would be true particularly where communities would see a particular event or a particular item from different perspectives. For example, one community may identify those companies or individuals for whom they provide products or services as “customer”. Whereas others may refer to the same companies or individuals as their “clients”. For a software company, this distinction, although slight, may be particularly challenging because the word “client” also relates to a particular piece of hardware in a “client-server” computer system environment or “client-server system architecture”. For example there would be, in such an instance, confusion between a “client” being a particular type of software operating on a particular computer or an individual who would compensate the software company for the products or services received.

At integration step 148, topics and associations are extracted from local model 142 and assembled in spreadsheets for importation into a Metis® model. Once in the Metis® model, these topics and associations may be integrated with other topics and associations. Integration step 148 further includes identifying synonyms both within the local taxonomy 146 as well as between local taxonomy 146 and other local taxonomies to achieve enterprise taxonomy 150. Using the above-described Zachman framework matrix 110 of FIG. 3, it is possible to extract a set of synonyms useful for integrate step 148. Enterprise taxonomy 150 is then deployed, at step 152. Lastly, local taxonomy 146 and associated synonym links are deployed, at step 152, into intellectual capital management system 154 as comma-separated-value files.

In enterprise taxonomy process 140, integrating step 140 involves identifying common terms across communities for associating preexisting taxonomies across the different communities. By integrating the different local taxonomies, it is possible to identify particular terms in the one local community as being identical or substantially similar to one or more terms appearing within one or more other local communities.

FIG. 5 illustrates the semantic network model used to manage the taxonomy content in a Metis® platform. In the present embodiment, the Metis® metamodeling system provides a staging tool for building enterprise taxonomy 150. Once built, enterprise taxonomy 150 may be exported from the Metis® environment in a tab-delimited format for use in a associated intellectual capital management system.

FIG. 5 shows an exemplary integrated enterprise taxonomy metamodel 160 formed according to the teachings of the present invention. In enterprise taxonomy metamodel 160, components include a taxonomy object type 162, a topic object type 164, an association relationship type 166, and the respective association 168. Properties within the taxonomy component 162 include the name 170, description 172, source file 174, source format 176, owner 178, and date 180. Properties within the topic component 164 include name 182, public name 184, taxonomy 186, instance 188, original name 190, original URI or universal resource identifier 192, date 194, canonical 196, and include 198. Properties for the association type relationship type 166 include “from” 200 and “to” 202. Association component 168 includes association type 204, origin topic object 206 and destination topic object 208.

FIG. 5, therefore, presents taxonomy metamodel 160 useful for building enterprise taxonomy 150 of FIG. 4. Taxonomy metamodel 160, through the various properties associated with taxonomy component 162, includes the name of the associated community, who owns the file, and the date of the file. Topic component 164 provides one topic instance for each node in the local taxonomy, wherein the terms within the taxonomy relate to specific topics. Accordingly, there may several thousands of topics within a given taxonomy. This would include taxonomy properties and combining them together. This is the essential part of the taxonomy term.

The taxonomy consists of taking the following three properties and combining them together. The components be “public name,” which may be, for example, the name by which the users see the term “healthcare financing agency.” This would be the public name for the community. The taxonomy would be the name for the local community taxonomy. For example, this could be the healthcare community taxonomy. The instance relates to the situation of a particular term appearing at multiple times within a given taxonomy.

Within a given taxonomy, it would not be unusual to have as many as half of the terms appear more than once within the taxonomy. Moreover, a given term may appear in multiple places within the given community. For example, one example could be of communities in the marketing area having terms for describing their particular industry. The marketing community would also have terms describing their services. If they list out their services, they would repeat the same terms from the listing of the industry. For example, in the healthcare community, there may be healthcare financing agencies represented as one of the organizations in the healthcare industry. On the other hand, in listing the services, the term “healthcare financing agency” would associate with the different services the healthcare marketing community may market to the healthcare financing agency. Thus, there is a need to account for the “healthcare” term not being a new term, but another instance of such term. “Healthcare” would appear, however, at a different place within the hierarchical tree representing the local taxonomy.

To address the multiple appearance of a particular a term, the first time a term appears in a local taxonomy, it receives the value “0.” The next time the same term appears the value changes to “1.” This process continues, resulting in the value “n+1” being the number of times the term appears in the taxonomy.

For any given topic, the name of the topic is established by concatenating the public name, the taxonomy name, and the instance number together into a compound name. This would uniquely identify a particular term or node out of all of the terms in all of the taxonomies. As a result, the set of term components would uniquely associate with particular terms and substantiate their instances in the particular taxonomy. In the example of FIG. 5, each name includes the three components of the public name, the taxonomy, and the instance value. Terms also have, within the taxonomies, an original class name. The original class name provides the ability to classify the terms from their original community model which would be listed.

The synonym terms within the text of all the taxonomies associated with the enterprise taxonomy can have a canonical synonym term. In semantic network modeling the term canonical, in a technical sense, addresses the challenge of the community taxonomies using different vocabularies. Because of the difficulty in handling many synonymous terms, a need exists to select one term as the most universal or canonical term. Although in some instances, the canonical synonym may not be the most universally accepted. Nonetheless, the present invention would preferentially select one term, either arbitrarily or with some infusion of logic, for providing or setting the canonical synonym.

From such a selection, the present invention identifies all of the instances of the term other than the canonical term as linking to or subordinate to the canonical term. These terms would be linked as synonyms to the canonical term. In the preferred embodiment the canonical terms are marked with a “1” in the canonical field and those which are not canonical would be marked with a “0”.

Referring to the taxonomy 160 of FIG. 5, the “include” term provides a signal the metamodel system to drop a term. For example, if, after the enterprise taxonomy gathers a taxonomy term, the metamodel determines to not use a term, the “include” field may be set to “0” to avoid this use. This flag, therefore, will drop the term from the local and, thus, the enterprise taxonomy.

The association type 204 provides connections between different topics. Association types 204 are relationship types to identify how one topic relates to another. If, for example, a topic “local area network” exists and there is another topic “server,” the association type may be the relationship “part of” in the network. Thus, the association types would provide the way of linking topics in a particular tree. Thus, in a network architecture the particular topics would be nodes and the associations types would be the links or arcs between the respective nodes. This is the metamodel and how it may be constructed.

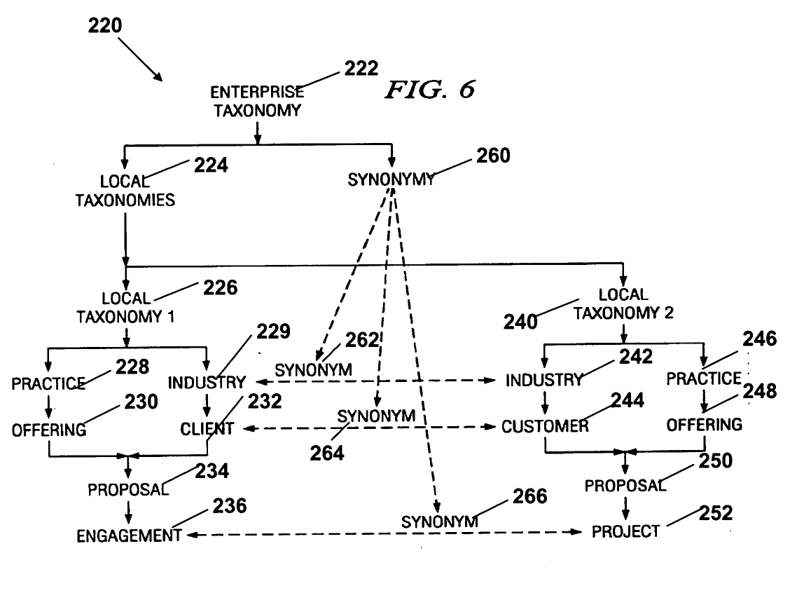

FIG. 6 shows the linkages between local taxonomies. In particular, FIG. 6 portrays, in association diagram 220, enterprise taxonomy 222 for demonstrating the workings of synonym relationships and local taxonomies. Local taxonomies 224, in this example, include local taxonomy 1 226 including hierarchically associates terms “practice” 228, “industry” 229, “offering” 230, “client” 232, “proposal” 234, and engagement 236. Local taxonomy 2 240 within the local taxonomies 224 set further includes the terms “industry” 242, “customer” 244, “practice” 246, “offering” 248, “proposal’ 250 and “project” 252. Synonymy association types 260 include synonym links 262, 264, and 266.

In local taxonomy 1, there is the term “industry” 229. Local taxonomy 2 also has the term “industry” 242. One of these terms would be designated as the “canonical” term with synonym link 262 between them. Thus, when a user desires to change the name “industry” into another term, the present allows knowing where within the taxonomy to go to make the change. This would allow all related terms to connect to the new or changed term. As a further example in the local taxonomy 1 226 there appears the term “client” 232. In local taxonomy 2 240, there appears, in contrast, the term “customer” 244 with synonym link 264 between them.

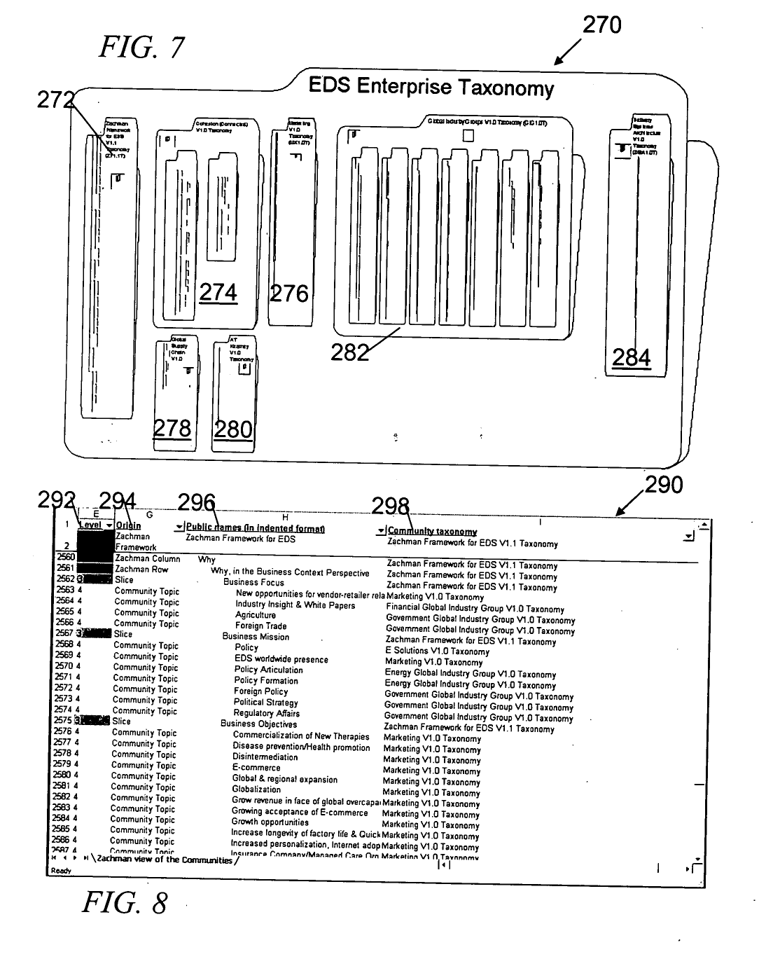

FIG. 7 provides an overall view of a taxonomy model 270, here an EDS Enterprise Taxonomy, according to the teachings of the present invention. Taxonomy model 270 includes, for example, Zachman Framework Taxonomy 272. Cohesion Taxonomy 274, Marketing Taxonomy 276, Global Supply Chain 278, and Kearney Taxonomy 280 form part of taxonomy model 270. Moreover, taxonomy model 270 includes Global Industry 282 and Delivery Systems Architecture Taxonomy 284. The overall view of taxonomy model 270, therefore, shows community taxonomy trees organized in separate folders or containers. Relationships between community taxonomies, exist, but are not here shown for the sake of legibility.

FIG. 8 is an example of a consistent section 290 of an enterprise taxonomy employing the concepts of the present invention. In the form of a computer spreadsheet, consistent section 290 includes Level column 292, Origin column 294, Public Names column 296, and community taxonomy column 298. Consistent section 290 draws content from various community taxonomies, linking them together under the Zachman Framework. The spreadsheet content was exported from taxonomy model 270 of FIG. 7.

Accordingly, the embodiments of the invention herein described, it should to be understood, are merely illustrative of the application of the principles of the invention. For example, although the present embodiment employs one or more versions of the Metis® metamodeling system, those metamodeling systems made by CaseWise®, Popkin®, and Slate® may also employ one or more embodiment of the present invention. In addition, the approach used for Metis® could be extended to other modeling systems and tools, such as Visio®, Popkin®, CaseWise®, or Slate®. Reference herein to details of the illustrated embodiments is not intended to limit the scope of the claims, which themselves recite those features regarded as essential to the invention.

1. A method for constituting an integrated enterprise taxonomy for an intellectual capital management system serving a plurality of local enterprise communities, comprising the steps of:
extracting a plurality of local taxonomies from the plurality of local enterprise community models;
correlating from each of said plurality of local taxonomies a set of topics and a set of associations for generating a correlated topics and associations set relating to each of said plurality of local taxonomies;
deriving a plurality of synonym links for linking synonyms within said correlated topics and associations set;
integrating said plurality of synonym links and said correlated topics and associations set into an integrated enterprise taxonomy; and
exporting said integrated enterprise taxonomy into said intellectual capital management system.

2. The method of claim 1, further comprising the step of determining internal consistency within each of said plurality of local taxonomies.

3. The method of claim 1, further comprising the steps of:
forming said correlated topics and associations set as a metamodel system; and
constituting said set of topics and associations to be correlated as relationships within said metamodel system.

4. The method of claim 1, wherein said exporting step further comprises the step of exporting said integrated enterprise taxonomy into said intellectual capital management system as a plurality of comma-separated-value files comprising said synonym links and said correlated topics and association set.

5. The method of claim 1, further comprising the steps of:
forming said correlated topics and associations set as a hierarchical tree structure within a metamodel system; and
forming said set of topics as node objects within said hierarchical tree structure; and
forming said set of associations as relationships between said node objects within said hierarchical tree structure.

6. The method of claim 1, further comprising the step of forming with said synonym links a canonical synonym link structure associated with a canonical synonym from among said synonyms, said canonical synonym link structure for associating non-canonical synonyms with said canonical synonym, said canonical synonym possessing a higher order than other ones of said synonyms.

7. The method of claim 1, further comprising the step of associating said integrated enterprise taxonomy with a plurality of enterprise documents associated with said intellectual capital management system.

8. The method of claim 1, further comprising the step of forming said integrated enterprise taxonomy as a metamodel system associated with said intellectual capital management system.

9. The method of claim 1, further comprising the step of forming said integrated enterprise taxonomy as a database associated with said intellectual capital management system.

10. A system for constituting an integrated enterprise taxonomy for an intellectual capital management system serving a plurality of local enterprise communities, comprising:
instructions for extracting a plurality of local taxonomies from the plurality of local enterprise communities;
instructions for correlating from each of said plurality of local taxonomies a set of topics and a set of associations for generating a correlated topics and associations set relating to each of said plurality of local taxonomies;
instructions for deriving a plurality of synonym links for linking synonyms within said correlated topics and associations set;
instructions for integrating said plurality of synonym links and said correlated topics and associations set into an integrated enterprise taxonomy; and
instructions for exporting said integrated enterprise taxonomy into said intellectual capital management system.

11. The system of claim 10, further comprising instructions for determining internal consistency within each of said plurality of local taxonomies.

12. The system of claim 10, further comprising:
instructions for forming said correlated topics and associations set as a metamodel system; and
instructions for constituting said set of topics and associations to be correlated as relationships within said metamodel system.

13. The system of claim 10, wherein said exporting instruction further comprise instructions for exporting said integrated enterprise taxonomy into said intellectual capital management system as a plurality of comma-separated-value files comprising said synonym links and said correlated topics and association set.

14. The system of claim 10, further comprising:
instructions for forming said correlated topics and associations set as a hierarchical tree structure within a metamodel system; and
instructions for forming said set of topics as node objects within said hierarchical tree structure; and
instructions for forming said set of associations as relationships between said node objects within said hierarchical tree structure.

15. The system of claim 10, further comprising instructions for forming with said synonym links a canonical synonym link structure associated with a canonical synonym from among said synonyms, said canonical synonym link structure for associating non-canonical synonyms with said canonical synonym, said canonical synonym possessing a higher order than other ones of said synonyms.

16. The system of claim 10, further comprising instructions for associating said integrated enterprise taxonomy with a plurality of enterprise documents associated with said intellectual capital management system.

17. The system of claim 10, further comprising instructions for forming said integrated enterprise taxonomy as a metamodel system associated with said intellectual capital management system.

18. The system of claim 10, further comprising instructions for forming said integrated enterprise taxonomy as a database associated with said intellectual capital management system.

19. A storage medium for constituting an integrated enterprise taxonomy for an intellectual capital management system serving a plurality of local enterprise communities, said storage medium comprising:
instructions for extracting a plurality of local taxonomies from the plurality of local enterprise communities;
instructions for correlating from each of said plurality of local taxonomies a set of topics and a set of associations for generating a correlated topics and associations set relating to each of said plurality of local taxonomies;
instructions for deriving a plurality of synonym links for linking synonyms within said correlated topics and associations set;
instructions for integrating said plurality of synonym links and said correlated topics and associations set into an integrated enterprise taxonomy; and
instructions for exporting said integrated enterprise taxonomy into said intellectual capital management system.

20. The storage medium of claim 19, further comprising:
instructions for forming said correlated topics and associations set as a hierarchical tree structure within a metamodel system; and
instructions for forming said set of topics as node objects within said hierarchical tree structure; and
instructions for forming said set of associations as relationships between said node objects within said hierarchical tree structure.
